(19) United States
(12) Patent Application Publication
(10) Pub. No.: US 2025/0238711 A1
(43) Pub. Date: Jul. 24, 2025

(54) SYSTEMS AND METHODS FOR PERSONALIZED FEDERATED LEARNING UNDER BITWIDTH FOR CLIENT RESOURCE AND DATA HETEROGENEITY

(71) Applicant: Toyota Motor Engineering & Manufacturing North America, Inc., Plano, TX (US)

(72) Inventors: Chianing Wang, Mountain View, CA (US); Alexander T. Pham, San Jose, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/421,231

(22) Filed: Jan. 24, 2024

(51) Int. Cl. G06N 20/00

(52) U.S. Cl. CPC G06N 20/00

(57) ABSTRACT

Provided is a system for personalized federated learning under bitwidth for client resource and data heterogeneity. The server includes one or more processors programmed to obtain quantized models under different bitwidth generated by client devices, de-quantize the quantized models by using global unlabeled data to run self-supervised learning (SSL), aggregate the de-quantized models, re-quantize the aggregated models based on the SSL and the global unlabeled data, and transmit the re-quantized models to the client devices.

### TECHNICAL FIELD

The present disclosure relates to systems and methods for federated learning, more specifically, to systems and methods for personalized federated learning under bitwidth for client resource and data heterogeneity.

### BACKGROUND

In vehicular technologies, such as object detection for vehicle cameras, the distributed learning framework is still under exploration. With the rapidly growing amount of raw data collected at individual vehicles, in the aspect of user privacy, the requirement of wiping out personalized, confidential information and the concern for private data leakage motivate a machine learning model that does not require raw data transmission. In the meantime, raw data transmission to the data center becomes heavier or even infeasible or unnecessary to transmit all raw data. Without sufficient raw data transmitted to the data center due to communication bandwidth constraints or limited storage space, a centralized model cannot be designed in the conventional machine learning paradigm. Federated learning, a distributed machine learning framework, is employed when there are communication constraints and privacy issues. The model training is conducted in a distributed manner under a network of many edge nodes (e.g., vehicles, mobile devices, etc.) and an edge server.

Although a federated learning system only transmits updates of local models instead of raw data between a server and edge nodes, the communication cost for uploading and downloading the parameters of models is still very high, especially for mobile edges because mobile edges have relatively unstable connection with a server. Moreover, the federated learning system usually has multiple iterations (i.e., runs/trails) between edge nodes and a centralized controller. In addition, the federated learning system increases the total uploading and downloading the parameters of models compared with a centralized machine learning system.

Another major challenge in a federated learning system results from the possible heterogeneity of decentralized data and edge node infrastructure resources. The edge node dataset may not be independent and identically distributed. The dataset in each edge node which is used for training might vary and proportional classes of images. Moreover, requiring all edge nodes locally train models with the same infrastructure resource is not practical. Edge nodes with less computation power are likely to be stragglers that dramatically increase total training time, and eventually delay iteration time because faster edge nodes always need to wait for slower edge nodes.

Accordingly, a need exists for federated learning that improves the performance of locally trained models at edge nodes in a federated learning network, controls communication costs among edge nodes and a server, and enhances accuracy of the trained models.

### SUMMARY

The present disclosure provides systems and methods for personalized federated learning under bitwidth for client resource and data heterogeneity.

In one embodiment, a system for personalized federated learning under bitwidth for client resource and data heterogeneity is provided. The server includes one or more processors programmed to obtain quantized models under different bitwidth generated by client devices, de-quantize the quantized models by using global unlabeled data to run self-supervised learning (SSL), aggregate the de-quantized models, re-quantize the aggregated models based on the SSL and the global unlabeled data, and transmit the re-quantized models to the client devices

In another embodiment, a method includes obtaining quantized models under different bitwidth generated by client devices, de-quantizing the quantized models by using global unlabeled data to run self-supervised learning (SSL), aggregating the de-quantized models, re-quantizing the aggregated models based on the SSL and the global unlabeled data, and transmitting the re-quantized models to the client devices.

In another embodiment, a non-transitory computer readable medium comprising instructions is provided. The instructions, when executed by a processor, cause the processor to perform: obtaining quantized models under different bitwidth generated by client devices; de-quantizing the quantized models by using global unlabeled data to run self-supervised learning (SSL); aggregating the de-quantized models; re-quantizing the aggregated models based on the SSL and the global unlabeled data; and transmitting the re-quantized models to the client devices.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts a system for federated learning using non-uniform quantization of parameters of machine learning models of heterogeneous edge nodes, in accordance with one or more embodiments shown and described herewith;

FIG. 1B depicts an exemplary machine learning model used in federated learning, in accordance with one or more embodiments shown and described herewith;

FIG. 2 depicts a schematic diagram of a system for personalized federated learning under different bitwidth using SSL, according to one or more embodiments shown and described herein;

FIG. 3 depicts a flowchart for aggregating machine learning models quantized in different bitwidth and transmitting re-quantized machine learning models to client devices, according to one or more embodiments shown and described herein;

FIG. 4 depicts a system for federated learning including a server and a plurality of heterogeneous client devices, in accordance with one or more embodiments shown and described herewith;

FIG. 5 depicts de-quantization, aggregation, and re-quantization performed by a server, in accordance with one or more embodiments shown and described herewith;

FIG. 6A and FIG. 6B depict experimental results including global and local accuracy when using different algorithms; and

FIG. 7 depicts computation cost and local accuracy for models with different bitwidths.

### DETAILED DESCRIPTION

The embodiments disclosed herein include systems and methods for federated learning using quantization self-supervised learning (QSSL) for training models in client devices and aggregating models by a server. The method of the present disclosure includes obtaining quantized models under different bitwidth generated by client devices, de-quantizing the quantized models by using global unlabeled data to run self-supervised learning (SSL), aggregating the de-quantized quantized models, re-quantizing the aggregated de-quantized quantized models based on the SSL and the global unlabeled data, and transmitting the re-quantized models to the client devices.

The quantization technique of the present disclosure reduces the upload/download bit. Non-uniform number of bits are utilized for different resource-heterogeneous clients. Non-Uniform Quantization is a quantization where the neural network parameters are quantized to lower bit value and low-bit operations are deploy in all steps, including the forward passing, backward propagation and last model matrix update. The quantization eventually reduces memory footprint. Less memory footprint then reduces computation resource, and eventually helps energy efficiency. When transferring the model from a client device to a server, the model is smaller because the model was quantized already for fitting client resource. Thus, the reduced size of the model also helps reducing the communication bandwidth.

The present disclosure leverages SSL to try to keep up accuracy with central learning. Because the non-uniform bitwidth quantization is utilized in the client devices, the server performs de-quantization to convert corresponding models from lower bitwidth models to full precision models, performs weighted aggregation on the full precision models, and perform re-quantization to convert the aggregated model to original low bitwidth models for returning back to the client devices. The present disclosure not only keeps high global accuracy but also continues to improve client accuracy.

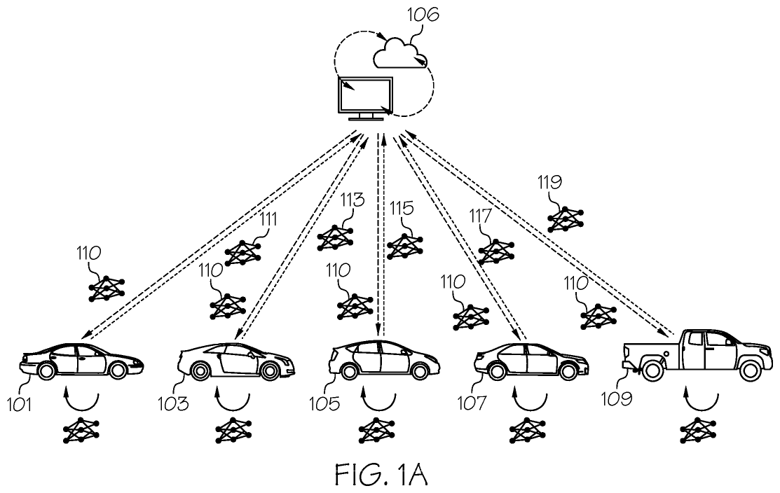

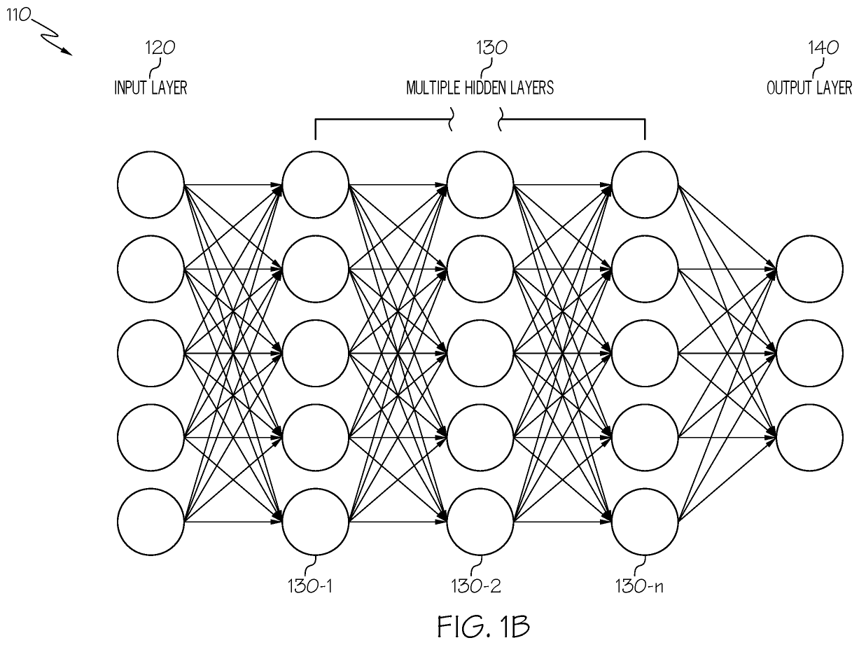

FIG. 1A schematically depicts a system for federated learning using non-uniform quantization of parameters of machine learning models of heterogeneous edge nodes, in accordance with one or more embodiments shown and described herewith.

The system includes a plurality of edge nodes 101, 103, 105, 107, and 109, and a server 106. Training for a machine learning model 110 is conducted in a distributed manner under a network of the edge nodes 101, 103, 105, 107, and 109 and the server 106. The machine learning model may include an image processing model, an object perception model, an object classification model, or any other model that may be utilized by vehicles in operating the vehicles. The machine learning model may include, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. While FIG. 1A depicts five edge nodes, the system may include more than or less than five edge nodes. Edge nodes 101, 103, 105, 107, and 109 may have different datasets and different computing resources, e.g., different GPUs, CPUs, and the like. The edge nodes 101, 103, 105, 107, 109 may have different datasets captured by their sensors because of different locations of the edge nodes 101, 103, 105, 107, 109, different driving routes of the edge nodes 101, 103, 105, 107, 109, different types of the sensors of the edge nodes 101, 103, 105, 107, 109, different specification of the sensors of the edge nodes 101, 103, 105, 107, 109, and the like. The network bandwidth for a channel between each of the edge nodes 101, 103, 105, 107, 109 and the server 106 may be varied depending on communication conditions.

In embodiments, each of the edge nodes 101, 103, 105, 107, and 109 may be a vehicle, and the server 106 may be a centralized server or an edge server. The vehicle may be an automobile or any other passenger or non-passenger vehicle such as, for example, a terrestrial, aquatic, and/or airborne vehicle. The vehicle may be an autonomous or semi-autonomous vehicle that navigates its environment with limited human input or without human input. Each vehicle may drive on a road and perform vision-based lane centering, e.g., using a forward facing camera. Each vehicle may include actuators for driving the vehicle, such as a motor, an engine, or any other powertrain. In some embodiments, each of the edge nodes 101, 103, 105, 107, and 109 may be an edge server, and the server 106 may be a centralized server. In some embodiments, the edge nodes 101, 103, 105, 107, and 109 are vehicle nodes, and the vehicles may communicate with a centralized server such as the server 106 via an edge server.

In embodiments, the server 106 sends an initialized machine learning model 110 to each of the edge nodes 101, 103, 105, 107, and 109. The initialized machine learning model 110 may be any model that may be utilized for operating a vehicle, for example, an image processing model, an object detection model, or any other model for advanced driver assistance systems. Each of the edge nodes 101, 103, 105, 107, and 109 trains the received initialized machine learning model 110 using local data to obtain an updated machine learning model 111, 113, 115, 117, or 119. The edge nodes 101, 103, 105, 107, and 109 may use non-uniform quantization in training the initialized machine learning model 110 depending on different local datasets and computing resources. Specifically, the edge nodes 101, 103, 105, 107, and 109 may quantize the parameters of the initialized machine learning model 110 to different bit values. For example, the edge node 101 utilizes 4-bit quantization, the edge node 103 utilizes 8-bit quantization, the edge node 105 utilizes 2-bit quantization, the edge node 107 utilizes 16-bit quantization, and the edge node 109 utilizes 32-bit quantization.

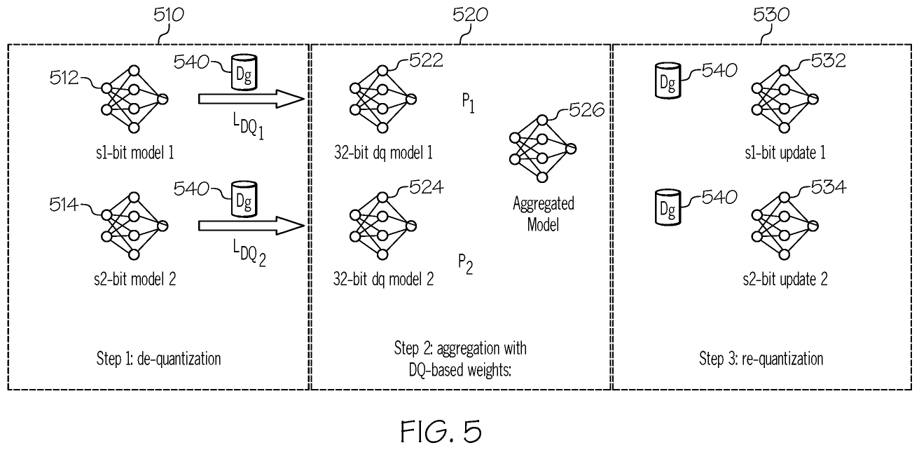

Then, each of the edge nodes 101, 103, 105, 107, and 109 sends the updated machine learning model 111, 113, 115, 117, or 119 or sends parameters of the updated machine learning model 111, 113, 115, 117, or 119 back to the server 106. The server 106 collects the updated machine learning models 111, 113, 115, 117, and 119, de-quantizes each of the updated machine learning models 111, 113, 115, 117, and 119 using small global unlabeled data to run self-supervised learning (SSL), aggregates the de-quantized machine learning models, and re-quantizes the aggregated de-quantized machine learning model in corresponding bitwidth that were used by the edge nodes 101, 103, 105, 107, and 109 based on the SSL and the small global unlabeled data. Then, the server 106 sends the re-quantized machine learning models to the edge nodes 101, 103, 105, 107, and 109. The details of the de-quantizing and re-quantizing will be further described in detail with reference to FIG. 5 below.

Due to communication and privacy issues in vehicular object detection applications, such as dynamic mapping, self-driving, and road status detection, the federated learning framework can be an effective framework for addressing issues in traditional centralized models. The edge nodes 101, 103, 105, 107, and 109 may be in different areas with different driving conditions. For example, some of the edge nodes 101, 103, 105, 107, and 109 are driving in a rural area, some are driving in a suburb, and some are driving in a city. In addition, the edge nodes 101, 103, 105, 107, and 109 may have different computing power and be equipped different types of sensors and/or different numbers of sensors.

In embodiments, when training the machine learning model 110, each of the edge nodes 101, 103, 105, 107, and 109 may compress parameters and outputs of layers of the machine learning model 110 using quantization. For example, the edge node 101 may train the machine learning model 110 as illustrated in FIG. 1B using local data. The machine learning model 110 includes parameters such as weights and/or biases for each of the layers of the machine learning model 110. The weights and/or biases may be quantized according to a first quantization level, e.g., a 4-bit. The first quantization level may be determined based on at least one of a memory footprint of the edge node 101, a computation power of the edge node 101, and a communication bandwidth between the edge node 101 and the server 106. Then, the local data as a data point is input to the input layer 120 of the machine learning model 110. With the data point and the quantized weights and/or biases, the first hidden layer 130-1 of the hidden layers 130 outputs first layer output values. The first layer output values are similarly quantized based on the first quantization level. Then, the quantized first layer output values are input to the second hidden layer 130-2 to output second layer output values. The calculation continues until the output of the last layer or the output layer 140 is generated.

Then, the edge node 101 computes gradients with respect to parameters from a last layer, or the output layer 140 to a first layer or the input layer 120 of the machine learning model 110 based on the quantized output and a cost function. The cost function quantifies the difference between an expected output and the quantized output. The edge node 101 quantizes the gradients based on a second quantization level. The second quantization level may be the same as or different from the first quantization level. The second quantization level may be determined based on at least one of a memory footprint of the edge node 101, and a computation power of the edge node 101. In determining the second quantization level, a communication bandwidth between the edge node 101 and the server 106 may not be considered. That is, the second quantization level may be purely determined by edge node constraints on local memory and computation. Then, the edge node 101 updates the machine learning model using the quantized gradients. Finally, the edge node 101 quantizes the parameters of the updated machine learning model again and transmits the quantized parameters of the updated machine learning model 111 to the server 106. Other edge nodes 103, 105, 107, and 109 similarly train the machine learning model 110 and transmit the quantized parameters of the updated machine learning models 113, 115, 117, and 119 to the server 106.

The server 106 collects the updated machine learning models 111, 113, 115, 117, and 119, de-quantizes each of the updated machine learning models 111, 113, 115, 117, and 119 using small global unlabeled data to run SSL, aggregates the de-quantized machine learning models, re-quantizes the aggregated de-quantized machine learning model in corresponding bitwidth that were used by the edge nodes 101, 103, 105, 107, and 109 based on the SSL and the small global unlabeled data, and sends the re-quantized machine learning models to the edge nodes 101, 103, 105, 107, and 109. Each of the edge nodes 101, 103, 105, 107, 109 may drive autonomously using corresponding re-quantized machine learning model. For example, each of the edge nodes 101, 103, 105, 107, 109 may use its re-quantized machine learning model to identify objects, classify the objects, and/or adjust vehicle parameters such as speeds, accelerations, directions of corresponding edge node.

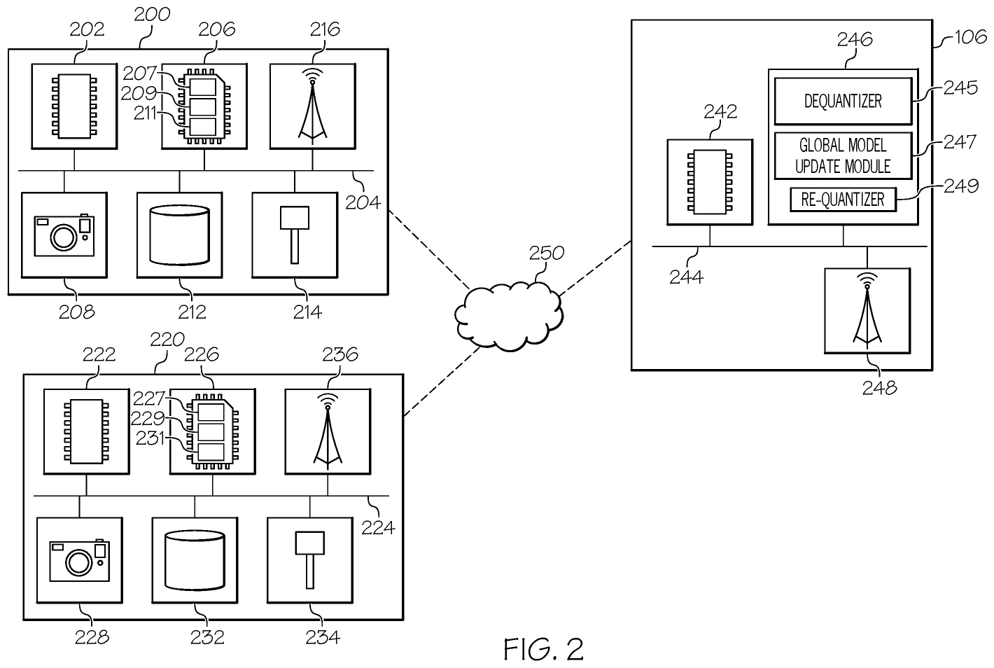

FIG. 2 depicts a schematic diagram of a system for personalized federated learning under different bitwidth using SSL, according to one or more embodiments shown and described herein. The system includes a first edge node system 200, a second edge node system 220, and the server 106. While FIG. 2 depicts two edge node systems, more than two edge node systems may communicate with the server 106.

It is noted that, while the first edge node system 200 and the second edge node system 220 are depicted in isolation, each of the first edge node system 200 and the second edge node system 220 may be included within a vehicle in some embodiments, for example, respectively within two of the edge nodes 101, 103, 105, 107, 109 of FIG. 1. In embodiments in which each of the first edge node system 200 and the second edge node system 220 is included within an edge node, the edge node may be an automobile or any other passenger or non-passenger vehicle such as, for example, a terrestrial, aquatic, and/or airborne vehicle. In some embodiments, the vehicle is an autonomous vehicle that navigates its environment with limited human input or without human input. In some embodiments, the edge node may be an edge server that communicates with a plurality of vehicles in a region and communicates with a centralized server such as the server 106.

The first edge node system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC), and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first edge node system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The one or more processor 202 along with the one or more memory modules 206 may operate as a controller for the first edge node system 200.

The one or more memory modules 206 includes a machine learning model module 207, a local dataset module 209, and a machine learning model training module 211. Each of the machine learning model module 207, the local dataset module 209, and the machine learning model training module 211 may include, but not limited to, routines, subroutines, programs, objects, components, data structures, and the like for performing specific tasks or executing specific data types as will be described below.

The machine learning model module 207 may include the machine learning model received from the server 106. For example, the machine learning model may be the initialized machine learning model received from the server 106. The machine learning model module 207 may also include a quantized machine learning model. The quantized machine learning model may be obtained based on training of the initialized machine learning model by running SSL with quantization.

The local dataset module 209 includes local data obtained by the first edge node system 200. For example, the local data may be data obtained by the one or more sensors 208 of the first edge node system 200.

The machine learning model training module 211 trains a machine learning model stored in the machine learning model module 207. The machine learning model training module 211 may train the initial machine learning model received from the server 106 using local data obtained by the first edge node system 200, for example, images obtained by imaging sensors such as cameras of a vehicle. The initial machine learning model may include, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. The machine learning model training module 211 quantizes the parameters of the initial machine learning model such as the machine learning model 110 in FIGS. 1A and 1B based on a predetermined quantization level. For example, the first quantization level may be 4 bit quantization. Then, the machine learning model training module 211 feeds the local data as a data point into the machine learning model 110 and trains the machine learning model using Self-Supervised Learning (SSL). The machine learning model training module 211 also quantizes the output of each layer of the machine learning model 110 based on the predetermined quantization level. The machine learning model training module 211 obtains the output of the last layer of the machine learning model 110 and quantizes the output of the last layer.

The machine learning model training module 211 may process backpropagation of the machine learning model 110 to compute gradients with respect to the parameters from the last layer 140 to the first layer 120 of the machine learning model 110 in FIG. 1B based on the quantized output calculated by the machine learning model training module 211. Specifically, the machine learning model training module 211 may obtain a cost function to quantify the difference between an expected output and the quantized output calculated by the machine learning model training module 211. Then, the machine learning model training module 211 computes gradients with respect to the parameters from the last layer 140 to the first layer 120 using the cost function. The machine learning model training module 211 quantizes the computed gradients based on the predetermined quantization level or other quantization level.

The machine learning model training module 211 may update the parameters of the machine learning model 110 using the quantized gradients generated by the machine learning model training module 211. For example, the machine learning model training module 211 may adjust the parameters of the machine learning model 110 using the quantized gradients such that the value of the cost function or loss is reduced. After the machine learning model training module 211 adjusted the parameters of the machine learning model 110, the machine learning model training module 211 quantizes the adjusted parameters of the machine learning model 110 based on another quantization level, and transmits the quantized and adjusted parameters of the machine learning model 111 to the server 106.

Referring still to FIG. 2, the first edge node system 200 comprises one or more sensors 208. The one or more sensors 208 may include a forward facing camera installed in a vehicle. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data to the one or more processors 202 or another component communicatively coupled to the communication path 204. In some embodiments, the one or more sensors 208 may also provide navigation support. That is, data captured by the one or more sensors 208 may be used to autonomously or semi-autonomously navigate a vehicle.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LIDAR sensors, radar sensors, sonar sensors, or other types of sensors for gathering data that could be integrated into or supplement the data collection described herein. Ranging sensors like radar sensors may be used to obtain a rough depth and speed information for the view of the first edge node system 200.

The first edge node system 200 comprises a satellite antenna 214 coupled to the communication path 204 such that the communication path 204 communicatively couples the satellite antenna 214 to other modules of the first edge node system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first edge node system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring motion and changes in motion of a vehicle, e.g., the edge node 101. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first edge node system 200 comprises network interface hardware 216 for communicatively coupling the first edge node system 200 to the second edge node system 220 and/or the server 106. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first edge node system 200 may transmit its data to the second edge node system 220 or the server 106. For example, the network interface hardware 216 of the first edge node system 200 may transmit vehicle data, location data, updated local model data and the like to the server 106.

The first edge node system 200 may connect with one or more external vehicle systems (e.g., the second edge node system 220) and/or external processing devices (e.g., the server 106) via a direct connection. The direct connection may be a vehicle-to-vehicle connection (“V2V connection”), a vehicle-to-everything connection (“V2X connection”), or a mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first edge node system 200 may be communicatively coupled to the server 106 by the network 250. In one embodiment, the network 250 may include one or more computer networks (e.g., a personal area network, a local area network, or a wide area network), cellular networks, satellite networks and/or a global positioning system and combinations thereof. Accordingly, the first edge node system 200 can be communicatively coupled to the network 250 via a wide area network, via a local area network, via a personal area network, via a cellular network, via a satellite network, etc. Suitable local area networks may include wired Ethernet and/or wireless technologies such as, for example, Wi-Fi. Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second edge node system 220 includes one or more processors 222, one or more memory modules 226, one or more sensors 228, one or more vehicle sensors 232, a satellite antenna 234, and a communication path 224 communicatively connected to the other components of the second edge node system 220. The components of the second edge node system 220 may be structurally similar to and have similar functions as the corresponding components of the first edge node system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the communication path 224 corresponds to the communication path 204, the network interface hardware 236 corresponds to the network interface hardware 216, a machine learning model module 227 corresponds to the machine learning model module 207, a local dataset module 229 corresponds to the local dataset module 209, and a machine learning model training module 231 corresponds to the machine learning model training module 211).

Still referring to FIG. 2, the server 106 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242. The one or more memory modules 246 may include a de-quantizer 245, a global model update module 247 and a re-quantizer 249. Each of the de-quantizer 245, the global model update module 247 and the re-quantizer 249 may include, but is not limited to, routines, subroutines, programs, objects, components, data structures, and the like for performing specific tasks or executing specific data types as will be described below.

The de-quantizer 245 may de-quantize the quantized parameters of updated machine learning models received from edge nodes. For example, each of the first edge node system 200 and the second edge node system 220 may send the quantized parameters of an updated machine learning model to the server 106. The de-quantizer 245 de-quantizes the quantized parameters of an updated machine learning model received from each of the first edge node system 200 and the second edge node system 220. In embodiments, the de-quantizer 245 de-quantizes the quantized machine learning models by using small global unlabeled data to run self-supervised learning. For example, the de-quantizer 245 de-quantizes the parameters of the quantized machine learning model received from the first edge node system 200 into parameters in 32-bit by running self-supervised learning using the small global unlabeled data.

The global model update module 247 aggregates de-quantized machine learning models from edge nodes. Specifically, by referring to FIG. 1A, the server 106 receives quantized parameters of the updated machine learning models 111, 113, 115, 117, and 119 from the edge nodes 101, 103, 105, 107, and 109. The de-quantizer 245 de-quantizes the quantized parameters of the updated machine learning models 111, 113, 115, 117, and 119. The global model update module 247 aggregates de-quantized parameters of the updated machine learning models 111, 113, 115, 117, and 119 to generate an aggregated machine learning model.

Specifically, the global model update module 247 determines weights for the updated machine learning models 111, 113, 115, 117, and 119 received from the edge nodes 101, 103, 105, 107, and 109. Then, the global model update module 247 may combine the updated machine learning models 111, 113, 115, 117, and 119 with the weights assigned to the updated machine learning models 111, 113, 115, 117, and 119. For example, the global model update module 247 may calculate weighted averages of the de-quantized parameters of the updated machine learning models 111, 113, 115, 117, and 119 based on the determined weights.

The re-quantizer 249 re-quantizes the aggregated machine learning model using the quantization levels that were used to previously quantize corresponding machine learning model. For example, the parameters of the updated machine learning model 111 was quantized in 4 bits by the first edge node system 200. Then, the re-quantizer 249 re-quantizes the aggregated machine learning model in 4 bits, and transmits the re-quantized machine learning model, i.e., 4-bit machine learning model, to the first edge node system 200. As another example, the parameters of the updated machine learning model 113 was quantized in 8 bits by the first edge node system 200. Then, the re-quantizer 249 re-quantizes the aggregated machine learning model in 8 bits, and transmits the re-quantized machine learning model, i.e., 8-bit machine learning model, to the second edge node system 220.

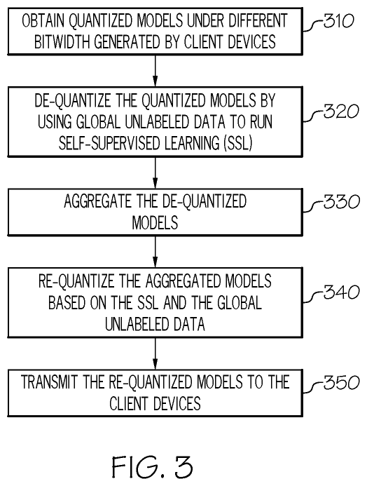

FIG. 3 depicts a flowchart for aggregating machine learning models quantized in different bitwidth and transmitting re-quantized machine learning models to client devices, according to one or more embodiments shown and described herein.

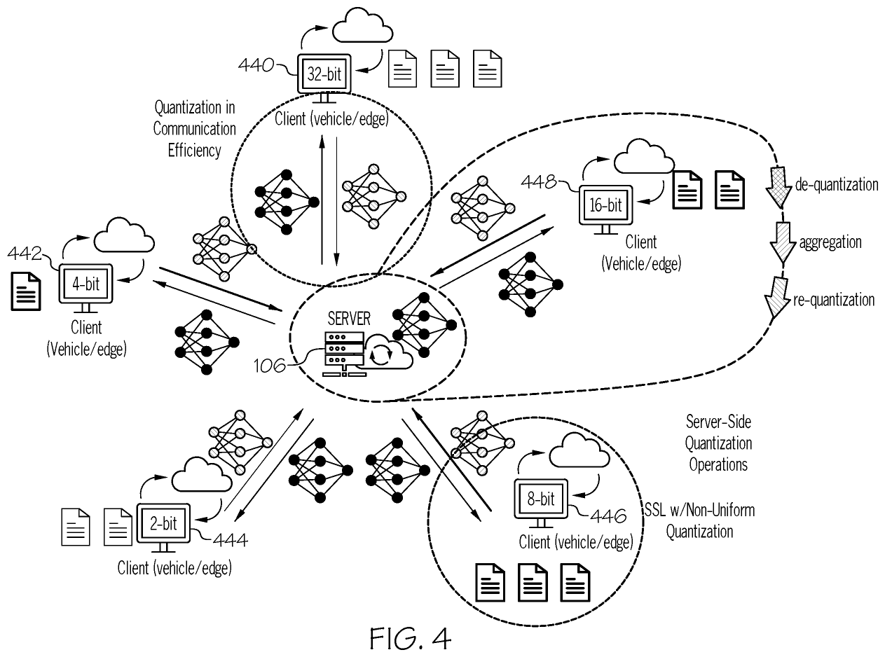

In step 310, a server obtains quantized machine learning models under different bitwidth generated by client devices. By referring to FIG. 4, each of the client devices 440, 442, 444, 446, 448 receives a machine learning model from the server. The client devices 440, 442, 444, 446, 448 may be vehicles or any other edge devices. Each of the client devices 440, 442, 444, 446, 448 trains the received machine learning model using its local dataset. Each of the client devices 440, 442, 444, 446, 448 trains the received machine learning model using self-supervised learning and the parameters of the received machine learning model are quantized to low bit values. For example, the parameters of the received machine learning model in the client device 440 are quantized to 32-bit values, the parameters of the received machine learning model in the client device 442 are quantized to 4-bit values, the parameters of the received machine learning model in the client device 444 are quantized to 2-bit values, the parameters of the received machine learning model in the client device 446 are quantized to 8-bit values, and the parameters of the received machine learning model in the client device 448 are quantized to 16-bit values. Then, each of the client devices 440, 442, 444, 446, 448 transmits its trained and quantized machine learning model to the server 106. Because the trained machine learning models are quantized before being transmitted to the server 106, it improves communication efficiency between the client devices 440, 442, 444, 446, 448 and the server 106. Once the server 106 obtains quantized machine learning models from the client devices 440, 442, 444, 446, 448, then the server 106 de-quantizes the machine learning models, aggregates the de-quantized machine learning models, and re-quantizes the aggregated machine learning model. The details of the de-quantization, aggregation, and re-quantization are described in steps 320, 330, 340 below.

Referring back to FIG. 3, in step 320, the server de-quantizes the quantized machine learning models by using global unlabeled data to run self-supervised learning (SSL). By referring to FIG. 5, Step 1 510 illustrates de-quantization process. For example, the server 106 receives two quantized machine learning models 512 and 514. The machine learning model 512 may correspond to the quantized machine learning model received from the client device 442 and the machine learning model 514 may correspond to the quantized machine learning model received from the client device 444. That is, the machine learning model 512 is quantized in 4 bits and the machine learning model is quantized in 2 bits. Then, the server de-quantizes the machine learning models 512 and 514 by using small global unlabeled data D_{g} 540 to run self-supervised learning. The small global unlabeled data may be uniform unlabeled data. For example, the uniform unlabeled data includes 100 images with 10 different categories, and each category includes 10 images. De-quantization may be viewed as a fine-tuning step on uniform unlabeled data. While performing the fine-tuning step, the server 106 determines losses L_{DQ1} and L_{DQ2} for the machine learning models. The losses are used to determine weights that are used for aggregating machine learning models in step 330. Lower loss means higher accuracy, and thus, the machine learning model that results in lower loss when fine-tuning is assigned a higher weight. The de-quantization converts the machine learning models 512 and 514 with lower precision (4-bit and 2-bit) to de-quantized machine learning models 522 and 524 with full precision (32-bit).

Referring back to FIG. 3, in step 330, the server 106 aggregates the de-quantized machine learning models. By referring to FIG. 5, step 2 520 illustrates aggregation with de-quantized-based weights. The server 106 aggregates the de-quantized machine learning models 522 and 524 with the de-quantized-based weights, p₁ and p₂ to obtain an aggregated machine learning model 526. As discussed above, the weights p₁ and p₂ are determined based on the losses L_{DQ1} and L_{DQ2} determined during de-quantization. For example, the weight pᵢ is calculated using Equation 1 below.

$${p}_{i} = \frac{{e}^{- {L}_{{DQ}_{i}}}}{{\sum }_{j} {e}^{- {L}_{{DQ}_{j}}}} \qquad Equation 1$$

Referring back to FIG. 3, in step 340, the server re-quantizes the aggregated machine learning models based on the SSL and the global unlabeled data. By referring to FIG. 5, step 3 530 illustrates re-quantization. The server re-quantizes the aggregated machine learning model 526 based on the SSL and the small global unlabeled data 540. For example, the machine learning model 512 was originally quantized in 4-bit by corresponding client device. In order for the client device to conduct local training, the aggregated machine learning model 526 with full precision (32-bit) should be converted to a lower-bit machine learning model. Thus, the server re-quantizes the aggregated machine learning model 526 to generate a lower-bit machine learning model, e.g., 4-bit quantized machine learning model 532. The machine learning model 514 was originally quantized in 2-bit by corresponding client device. In order for the client device to conduct local training, the aggregated machine learning model 526 with full precision (32-bit) should be converted to a lower-bit machine learning model. Thus, the server 106 re-quantizes the aggregated machine learning model 526 to generate a lower-bit machine learning model, e.g., 2-bit quantized machine learning model 532.

Referring back to FIG. 3, in step 350, the server 106 transmits the re-quantized machine learning models to the client devices. By referring to FIG. 4, the server 106 transmits the re-quantized machine learning models to the client devices 440, 442, 444, 446, 448. Specifically, the server 106 transmits 4-bit re-quantized machine learning model to the client device 442, transmits 2-bit re-quantized machine learning model to the client device 444, transmits 8-bit re-quantized machine learning model to the client device 444, and transmits 16-bit re-quantized machine learning model to the client device 448. Because the client device 440 can manage 32-bit machine learning model, the server 106 may not need to send a re-quantized machine learning model, but merely send an aggregated machine learning model, for example, the aggregated machine learning model 526 in FIG. 5.

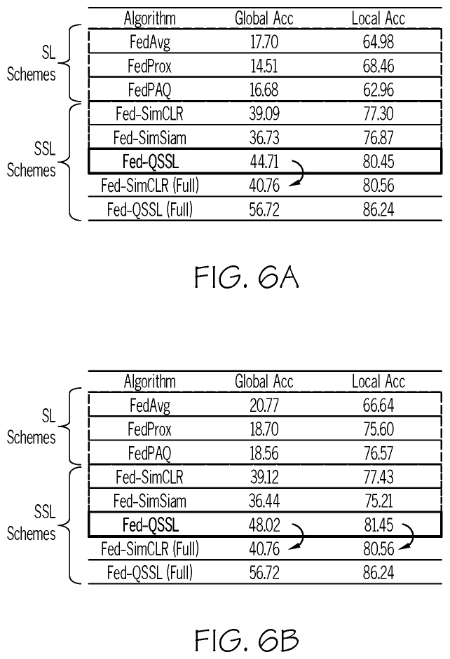

FIG. 6A and FIG. 6B depict experimental results including global and local accuracy when using different algorithms.

FIG. 6A shows experiments on CIFAR-10 with model bitwidth configuration 20% 4-bit, 30% 6-bit, 30% 8-bit, and 20% 12 bit. FIG. 6B shows experiments on CIFAR-10 with model bitwidth configuration 50% 6-bit and 50% 12-bit. The experiments are performed using the following conditions: Federated Learning system with 10 clients, 100 communication rounds with 5 local epochs per round; ResNet-based neural network architecture; Global accuracy tested on uniform distribution; local accuracy tested on local non-iid (Dirichlet (0.1)) distributions; Full means all 32-bit models (No Quantization but only SSL).

Fed-Quantization Serving Supervised Learning (Fed-QSSL) is the model according to the present disclosure. The table in FIG. 6A includes Supervised Learning (SL) schemes and Self-Supervised Learning (SSL) schemes. SL schemes include FedAvg, FedProx, FedPAQ and SSL schemes include Fed-SimCLR, Fed-Sim Siam, and Fed-QSSL.

FedAvg is a classic Federated Averaging by the number of clients. FedProx addresses client data heterogeneity by adding an l2-norm regularizer to local objectives to prevent divergence of local updates from the global model. FedPAQ is a communication-efficient FL algorithm where clients transmit quantized updates to reduce uplink communication cost.

Fed-SimCLR uses contrastive learning objective to learn a global feature extraction model. Fed-SimSiam considers only positive pairs of data points and learns meaningful features by leveraging a feature predictor function and stop-gradient operation.

According to the experiments, Fed-QSSL achieves better global accuracies, showing robustness under the same bitwidth (Quantization) constraints. Fed-QSSL achieves better local accuracies since robust representations are learned. Fed-QSSL reaches higher global accuracies and local accuracies together, while a trade-off exists in SL. That is, SL schemes can have high accuracy in global accuracy or local accuracy. With more bitwidth allowance, most schemes reach higher accuracies.

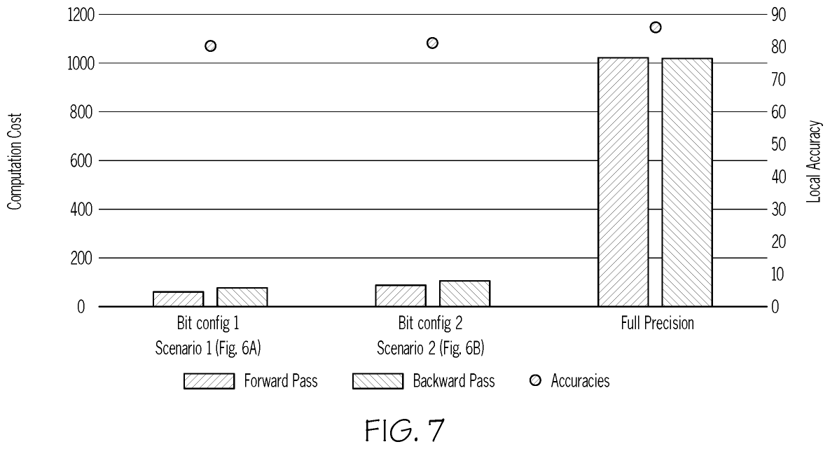

FIG. 7 depicts computation cost and local accuracy for models with different bitwidths. The computation cost are collected via computation from the number of bits for local training (cost ab for operations between a-bit values and b-bit values) and averaging over all clients. When comparing scenario 1 of Fed-QSSL in FIG. 6A, scenario 2 of Fed-QSSL in FIG. 6B and Full-Precision (Non-Quantization), Fed-QSSL achieves accuracy close to the full precision counterpart while using less than 1/10 of the computation cost of the full precision counterpart.

In summary, these experiments show Fed-QSSL can reduce memory footprint, computation resource, and the bandwidth via non-uniform quantization. Utilizing SSL with unlabeled dataset in local client training and server-side operation may keep up or even improve the performance (global and local accuracy) even under the quantitation technique limitation.

It should be understood that embodiments described herein are directed. In embodiments, a method includes obtaining quantized models under different bitwidth generated by client devices; de-quantizing the quantized models by using global unlabeled data to run self-supervised learning (SSL); aggregating the de-quantized quantized models; re-quantizing the aggregated de-quantized quantized models based on the SSL and the global unlabeled data; and transmitting the re-quantized models to the client devices.

The quantization technique of the present disclosure reduces the upload/download bit. Non-uniform number of bits are utilized for different resource-heterogeneous clients. Non-Uniform Quantization is a quantization where the neural network parameters are quantized to lower bit value and low-bit operations are deploy in all steps, including the forward passing, backward propagation and last model matrix update. The quantization eventually reduces memory footprint. Less memory footprint then reduces computation resource, and eventually helps energy efficiency. When transferring the model from a client device to a server, the model is smaller because the model was quantized already for fitting client resource. Thus, the reduced size of the model also helps reducing the communication bandwidth.

The present disclosure leverages SSL to try to keep up accuracy with central learning. Because the non-uniform bitwidth quantization is utilized in the client devices, the server performs de-quantization to convert corresponding models from lower bitwidth models to full precision models, performs weighted aggregation on the full precision models, and perform re-quantization to convert the aggregated model to original low bitwidth models for returning back to the client devices. The present disclosure not only keeps high global accuracy but also continues to improve client accuracy.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
one or more processors programmed to:
obtain quantized models under different bitwidth generated by client devices;
de-quantize the quantized models by using global unlabeled data to run self-supervised learning (SSL);
aggregate the de-quantized models;
re-quantize the aggregated models based on the SSL and the global unlabeled data; and
transmit the re-quantized models to the client devices.

2. The system of claim 1, wherein the one or more processors are further programmed to:
determine weights for the quantized models based on training loss of de-quantizing the quantized models; and
aggregate the de-quantized models with the weights.

3. The system of claim 1, wherein the quantized models under different bitwidth are trained using the SSL.

4. The system of claim 1, wherein:
the client devices have different computing resources, and
the quantized models under different bitwidth are quantized based on non-uniform quantization.

5. The system of claim 1, further comprising:
one or more memories storing the global unlabeled data with uniform distribution.

6. The system of claim 1, wherein the de-quantization converts the quantized models from the different bitwidth to a full precision bitwidth greater than the different bitwidth.

7. The system of claim 6, wherein the re-quantization quantizes the aggregated models from the full precision bitwidth to the different bitwidth.

8. The system of claim 1, wherein the client devices are autonomous driving vehicles or edge devices.

9. A method comprising:
obtaining quantized models under different bitwidth generated by client devices;
de-quantizing the quantized models by using global unlabeled data to run self-supervised learning (SSL);
aggregating the de-quantized models;
re-quantizing the aggregated models based on the SSL and the global unlabeled data; and
transmitting the re-quantized models to the client devices.

10. The method of claim 9, further comprising:
determining weights for the quantized models based on training loss of de-quantizing the quantized models; and
aggregating the de-quantized models with the weights.

11. The method of claim 9, wherein the quantized models under different bitwidth are trained using the SSL.

12. The method of claim 9, wherein:
the client devices have different computing resources, and
the quantized models under different bitwidth are quantized based on non-uniform quantization.

13. The method of claim 9, wherein the global unlabeled data are unlabeled data with uniform distribution.

14. The method of claim 9, wherein the de-quantizing converts the quantized models from the different bitwidth to a full precision bitwidth greater than the different bitwidth.

15. The method of claim 14, wherein the re-quantizing quantizes the aggregated models from the full precision bitwidth to the different bitwidth.

16. The method of claim 9, wherein the client devices are autonomous driving vehicles or edge devices.

17. A non-transitory computer readable medium comprising instructions, when executed by a processor, causing the processor to perform:
obtaining quantized models under different bitwidth generated by client devices;
de-quantizing the quantized models by using global unlabeled data to run self-supervised learning (SSL);
aggregating the de-quantized models;
re-quantizing the aggregated models based on the SSL and the global unlabeled data; and
transmitting the re-quantized models to the client devices.

18. The non-transitory computer readable medium of claim 17, wherein the instructions, when executed by the processor, cause the processor to further perform:
determining weights for the quantized models based on training loss of de-quantizing the quantized models; and
aggregating the de-quantized models with the weights.

19. The non-transitory computer readable medium of claim 17, wherein the quantized models under different bitwidth are trained using the SSL.

20. The non-transitory computer readable medium of claim 17, wherein:
the client devices have different computing resources, and
the quantized models under different bitwidth are quantized based on non-uniform quantization.
